(19) United States
(12) Patent Application Publication
(10) Pub. No.: US 2017/0211472 A1
(43) Pub. Date: Jul. 27, 2017

(54) ENGINE CLEANSING DEVICE AND ENGINE CLEANSING METHOD

(71) Applicant: HK TECHNOLOGY CO., LTD., Gunpo-si, Gyeonggi-do (KR)

(72) Inventor: Il Man HEO, Gyeonggi-do (KR)

(21) Appl. No.: 14/769,088

(22) PCT Filed: Jun. 18, 2015
(86) PCT No.: PCT/KR2015/006190

§ 371 Date: Mar. 3, 2017

(30) Foreign Application Priority Data
Jun. 18, 2014 (KR) 10-2014-0074196

(51) Int. Cl. F02B 77/04; B08B 1/00; A46B 13/00; A46B 5/00; A46B 13/08; B08B 9/045; B08B 1/04

(52) U.S. Cl. CPC F02B 77/04; B08B 9/045; B08B 1/002; B08B 1/04; A46B 5/0037; A46B 5/0066; A46B 5/0083; A46B 13/08; A46B 13/001; F02B 2077/045

(57) ABSTRACT

The present invention relates to a vehicle engine-washing apparatus and a washing method using the washing apparatus, and more particularly, to a vehicle engine-washing engine for washing the inside of vehicle engine, which apparatus includes a hollow operation tube; a guide part having a body inserted into a tip portion of the operation tube and formed with a through-hole, and a leading-in tube formed on the body in such a manner as to communicate with the through-hole; a holder fitted on and fixed to an outer circumferential surface of the operation tube and having a tapered part and an engagement panel formed at an end of the tapered part; an end cap fitted to a terminal end portion of the operation tube and formed with an operation hole; an operation rod inserted through the operation hole of the end cap and having a coupling protrusion formed at one end of the operation rod and a coupling groove formed at the other end; a hollow connection socket disposed in the operation tube, the other end portion of the socket being fitted on the coupling protrusion introduced into the operation tube; and a washing rod having an inserted protrusion formed at one side thereof which is inserted into one end portion of the connection socket, and a brush part provided at the other side, whereby effects are obtained that washing of the inside of the engine is allowed without having to separate the engine, thereby significantly reducing cost and time for maintenance, and anyone can conveniently perform the washing.

### TECHNICAL FIELD

The present invention relates to a vehicle engine-washing apparatus and a washing method using the washing apparatus, and more particularly, a vehicle engine-washing apparatus and a washing method using the washing apparatus which allow washing of the inside of the engine without having to separate the engine, thereby significantly reducing cost and time for maintenance, and enable anyone to conveniently perform the washing, by introducing washing liquid through a coupling hole from which a spark plug of CDI engine has been separated, thereafter, inserting a leading-in tube provided in an operation tube and then withdrawing a washing rod through the leading-in tube and rotating an operation rod connected to the washing rod by means of a rotating tool to thus wash an inner surface of the engine with a brush part of the washing rod.

### BACKGROUND ART

In general, a vehicle engine requires an ignition device generating sparks in a cylinder and the ignition device is an important element as an engine performance depends on the type and function of the ignition device.

As an ignition device for vehicle gasoline engine, in the beginning a high-pressure magnet type has been used which is excellent in high-speed rotation performance, however, a battery ignition type having a good start capability is mainly used nowadays.

In such a vehicle engine, an engine oil coagulates on or sticks to an inner wall due to combustion heat and thus a waste oil with no lubrication function is generated, and remaining material such as sludge, tar, soot, etc. except the waste oil coagulates on or sticks to the inner wall. Such waste oil and remaining material (sludge, tar, soot, etc.) on the inner wall of the vehicle engine increase a friction coefficient of the engine oil, thus causing an increase of engine noise, overheating of the engine and a decrease of acceleration force of the engine. Accordingly, problems appear that the life of the vehicle engine is shortened, a fuel efficiency is lowered and frequent change of engine oil is required.

Therefore, after running of the vehicle for a certain period of time, the inside of the vehicle engine has to be washed to remove the waste oil and remaining material.

In this connection, when the engine oil of the vehicle engine is manually changed, a drain plug of an oil pan is opened to discharge the waste oil in the engine, and thereafter, an oil cap on an upper part of the vehicle engine is opened to inject a new engine oil. However, there is a problem that the remaining material in the vehicle engine cannot be discharged.

So, washing apparatuses of various configurations have been developed and used for discharging the waste oil and remaining material of the vehicle engine. As described in Korean U.M. Application No. 20-2002-0023939 as a related art, pollutants in the cylinder are removed by pumping and circulating oil and washing liquid.

However, the prior washing apparatus has a problem that as the pollutants are removed by circulation of the oil and washing liquid, there is a limit to removing the waste oil, sludge and tar formed by accumulating and coagulating on the inner wall of the cylinder.

### SUMMARY OF THE INVENTION

### Technical Problems

The present invention has been made for solving the above-mentioned problems, and its object is to provide a vehicle engine-washing apparatus and a washing method using the washing apparatus which allow washing of the inside of the engine without having to separate the engine, thereby significantly reducing cost and time for maintenance, and enable anyone to conveniently perform the washing, by introducing washing liquid through a coupling hole from which a spark plug of CDI engine has been separated, thereafter, inserting a leading-in tube provided in an operation tube and then withdrawing a washing rod through the leading-in tube and rotating an operation rod connected to the washing rod by means of a rotating tool to thus wash an inner surface of the engine with a brush part of the washing rod.

### Solution to the Problem

The present invention provides a vehicle engine-washing engine for washing the inside of vehicle engine, comprising a hollow operation tube; a guide part having a body inserted into a tip portion of the operation tube and formed with a through-hole, and a leading-in tube formed on the body in such a manner as to communicate with the through-hole; a holder fitted on and fixed to an outer circumferential surface of the operation tube and having a tapered part and an engagement panel formed at an end of the tapered part; an end cap fitted to a terminal end portion of the operation tube and formed with an operation hole; an operation rod inserted through the operation hole of the end cap and having a coupling protrusion formed at one end of the operation rod and a coupling groove formed at the other end; a hollow connection socket disposed in the operation tube, the other end portion of the socket being fitted on the coupling protrusion introduced into the operation tube; and a washing rod having an inserted protrusion formed at one side thereof which is inserted into one end portion of the connection socket, and a brush part provided at the other side.

Further, the brush part has a fixing cap and multiple bristles, one end of each bristle being fixed in the fixing cap, and the bristles are made of synthetic resin material wires or metal wires.

Further, the body is further coupled with an annular angle-adjusting ring having a curved supporting surface and made of elastic synthetic resin material, and bearings are further provided in the through-hole of the body and the operation hole of the end cap to prevent frictions of the operation rod and the washing rod.

Further, the washing rod is further provided with a flexible washing device, and the flexible washing device has an elastic spring connecting an end of the washing rod and the fixing cap of the brush part and a flexible hose which is fitted over the elastic spring while surrounding the spring and which is connected with the end of the washing rod and the brush part, and a plurality of flexible bristles are further formed on an outer surface of the flexible hose.

The present invention also provides a method of washing the inside of vehicle engine provided with a spark plug-coupling hole by the use of the vehicle engine-washing apparatus, which method includes a chemical-introducing step where washing chemical is introduced through the coupling hole from which the spark plug of the engine has been separated; a leading-in tube-coupling step where the leading-in tube is introduced into the coupling hole of the engine; a brush part-withdrawing step where after the leading-in tube has been introduced so that the body is caught by the coupling hole, the operation rod is pressed toward the coupling hole to move the connection socket and the washing rod sequentially connected to the operation rod, thereby withdrawing the brush part formed at the end of washing rod so that the brush part is exposed outwardly from the leading-in tube; a tool-coupling step where the rotating tool is coupled with the coupling groove formed on the operation rod of the washing apparatus, and a washing step where the rotating tool is rotated to allow the brush part to wash the inside of the engine; and a discharging step where the washed chemical is discharged by being pumped through a pump after the washing step.

### Effects of the Invention

The vehicle engine-washing apparatus and the washing method using the washing apparatus of the present invention has advantages that washing of the inside of the engine is allowed without having to separate the engine, thereby significantly reducing cost and time for maintenance, and anyone can conveniently perform the washing, by introducing washing liquid through a coupling hole from which a spark plug of CDI engine has been separated, thereafter, inserting a leading-in tube provided in an operation tube and then withdrawing a washing rod through the leading-in tube and rotating an operation rod connected to the washing rod by means of a rotating tool to thus wash an inner surface of the engine with a brush part of the washing rod.

### BRIEF DESCRIPTION OF THE DRAWINGS

FIG. 1 is a perspective view illustrating a vehicle engine-washing apparatus according to the present invention;

FIG. 2 is a sectional view illustrating the vehicle engine-washing apparatus according to the present invention;

FIG. 3 is a view illustrating a washing rod of the vehicle engine-washing apparatus according to the present invention;

FIG. 4 is a view illustrating a state of operation of the vehicle engine-washing apparatus according to the present invention;

FIG. 5 is a view illustrating a state of use of the vehicle engine-washing apparatus according to the present invention;

FIG. 6 is a view illustrating another embodiment of the vehicle engine-washing apparatus according to the present invention; and

FIG. 7 is a flowchart illustrating a method of washing a vehicle engine according to the present invention.

### BEST MODES FOR CARRYING OUT THE INVENTION

Hereinafter, referring to the attached drawings, a description will be made of a preferred embodiment of a washing apparatus for washing a vehicle engine according to the present invention. In this connection, it should be noted that thicknesses of lines, dimensions of elements, etc. illustrated in the drawings may be exaggerated for the sake of clarity and convenience of the description. Further, terms described hereinafter are terms defined considering functions in the present invention and may be varied depending on an intention or practice of a user or operator. Therefore, such terms should be defined based on contents throughout the specification.

Further, the following embodiment does not limit the scope of claims of the present invention, rather is illustrative, and there may be various embodiments made through technical concepts of the present invention.

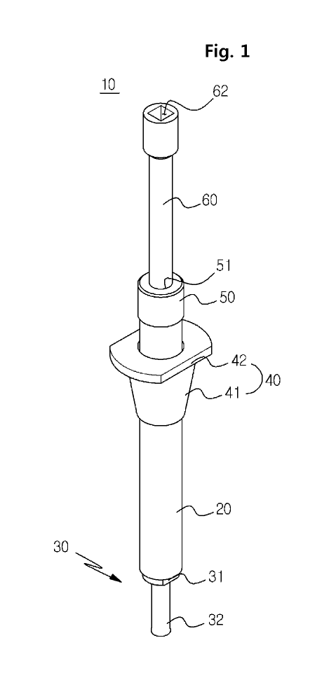

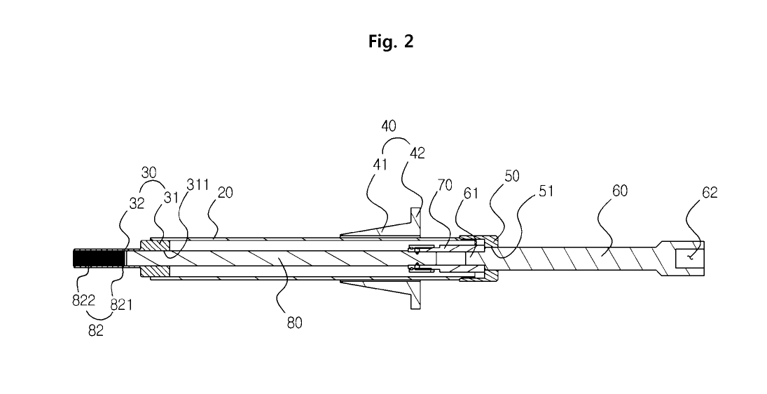

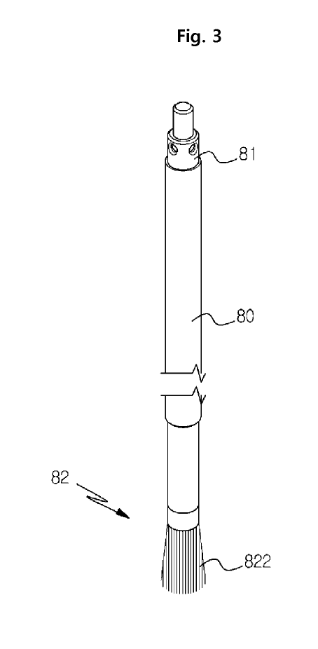

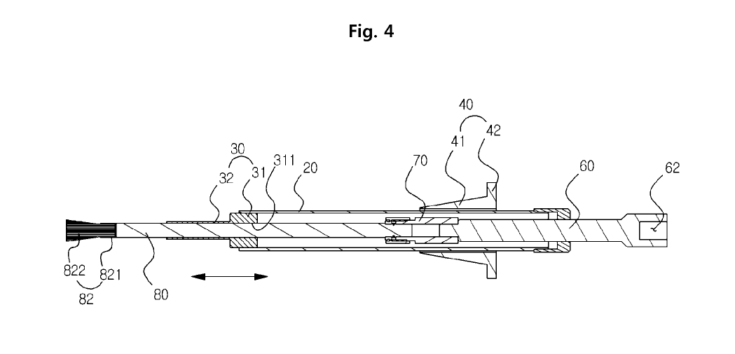

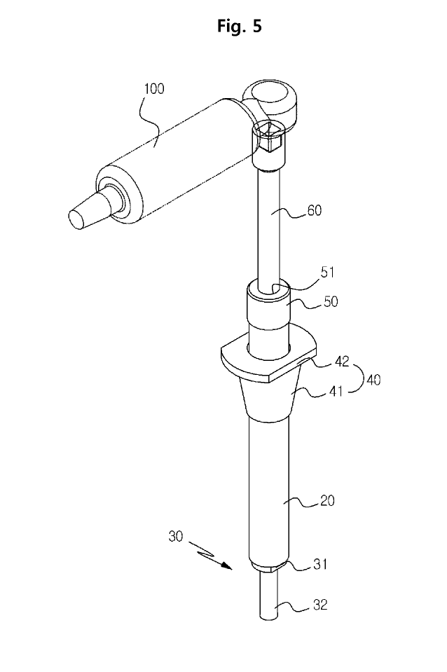

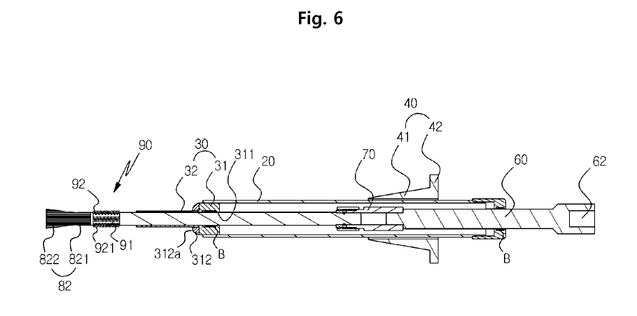

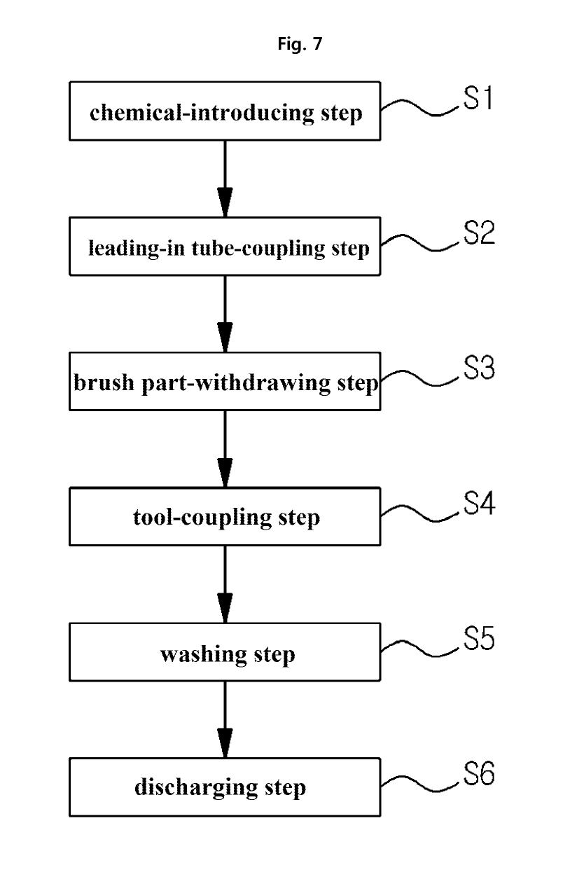

FIG. 1 is a perspective view illustrating a vehicle engine-washing apparatus according to the present invention, FIG. 2 is a sectional view illustrating the vehicle engine-washing apparatus according to the present invention, FIG. 3 is a view illustrating a washing rod in the vehicle engine-washing apparatus according to the present invention, FIG. 4 is a view illustrating a state of operation of the vehicle engine-washing apparatus according to the present invention, FIG. 5 is a view illustrating a state of use of the vehicle engine-washing apparatus according to the present invention, FIG. 6 is a view illustrating another embodiment of the vehicle engine-washing apparatus according to the present invention, and FIG. 7 is a flowchart illustrating a method of washing a vehicle engine according to the present invention.

As illustrated in the drawings, a vehicle engine-washing apparatus (10)(hereinafter, referred to as a washing apparatus for the sake of convenience of the description) is a washing apparatus for washing the inside of a engine by introducing washing liquid through a spark plug-coupling hole after disassembling at least one spark plug installed on an engine (CDI engine) of the engine. Such a washing apparatus (10) includes an operation tube (20), a guide part (30), a holder (40), an end cap (50), an operation rod (60), a connection socket (70) and a washing rod (80).

The operation rod (20) is formed as a hollow tube made of metal or synthetic resin material.

The guide part (30) is made of metal material and includes a body (31) inserted into a tip portion of the operation tube (20) and welded or screwed into the tip portion and formed with a through-hole (311), and a leading-in tube (32) integrally formed with the body (31) in such a manner as to communicate with the through-hole (311).

In this connection, the leading-in tube (32) is introduced into the coupling hole from which the spark plug has been removed.

The holder (40) is fitted on an outer circumferential surface of the operation tube (20) and forcedly fixed thereto. As illustrated in FIG. 1, the holder includes a tapered part (41) with its outer surface downwardly tapered and an engagement panel (42) integrally formed with an end of the tapered part (41). A user fixes the operation tube (20) by gripping the engagement pane (42) while inserting the tapered part (41) between two fingers of the user.

The end cap (50) is made of metal material or synthetic resin material and fitted to a terminal end portion of the operation tube (20) and is formed with an operation hole (51). The end cap (50) is releasably screwed onto the terminal end portion of the operation tube (20) or may be otherwise forced-fitted.

The operation rod (60) is inserted through the operation hole (51) of the end cap (50) and has a coupling protrusion (61) formed at an inserted end and a coupling groove (62) formed at the other end exposed to the outside. A rotating tool (100) is coupled with the coupling groove (62) to rotate the operation rod (60).

The connection socket (70) is formed as a hollow tube structure and disposed in the operation tube (20), wherein the other end portion of the socket is forced-fitted on the coupling protrusion (61) of the operation rod (60) introduced into the operation tube (20) or fitted on the coupling protrusion and then screw-fastened thereto. Further, one end portion of the connection socket (70) is releasably fitted on and fixed to the washing rod (80).

In this connection, the one end portion of the connection socket (70) is releasably screwed onto the washing rod (80) or may be otherwise fitted on and screw-fastened to the washing rod or may be forced-fitted thereon. The one end portion of the connection socket (70) may be provided with a conventional elastic coupling means consisting of an elastic spring and a ball and an inserted protrusion of the washing rod may be formed with an insertion groove in which an end of the ball is inserted.

The washing rod (80) has an inserted protrusion (81) formed at one side thereof which is inserted into the one end portion of the connection socket (70) and has a brush part (82) at the other side, which brush part (82) washes an inner surface of the engine while being rotated by the rotation of the rotating tool (100) after the tool has been coupled with the coupling hole (62).

The brush part (82) includes a metallic fixing cap (821) and multiple bristles (822), one end of each bristle being inserted and fixed in the fixing cap (821). The bristles (822) are made of synthetic resin material wires or metal wires. The bristles (822) are fixed by adhesive or by compressing the fixing cap (821), after have been inserted in the fixing cap (821).

When an operator presses the operation rod toward the leading-in tube (32) while rotating the rod, the washing rod (80) is withdrawn out of the leading-in tube (32) and accordingly the bristles (822) are pressed against the inner surface of the engine while being rotated and thus rub against the inner surface of the engine to separate foreign matter using the washing liquid introduced through the coupling hole and applied to the inner surface. In the course of washing, the brush part is radially bent by being continuously pressed against the inner surface of the engine while being rotated. The brush part is retracted into or withdrawn out of the leading-in tube (32) as illustrated in FIG. 4 and thus the bent bristles (822) are prevented from being caught and can be easily stored.

Referring to FIG. 6, the body (31) is further coupled with an annular angle-adjusting ring (312) having a curved supporting surface (312a) and made of elastic synthetic resin material. Bearings (B) are provided in the through-hole (311) of the body (31) and the operation hole (51) of the end cap (50) to prevent frictions of the operation rod (60) and the washing rod (80). The angle-adjusting ring (312) is pressed against the coupling hole to prevent the apparatus from being slipped or moved in the course of pressing and rotation, and the curved supporting surface (312a) allows an angle of the leading-in tube (32) introduced through the coupling hole of the engine to be varied, whereby a washed area of the inner surface of the engine can be increased. It is preferable that the leading-in tube (32) has a smaller diameter than that of the coupling hole so that it can be moved after introduced through the coupling hole.

Further, the washing rod (80) is further provided with a bendable washing device (90). The bendable washing device (90) includes an elastic spring (91) connecting an end of the washing rod (80) and the fixing cap (821) of the brush part (82) and a flexible hose (92) which is fitted over the elastic spring (91) while surrounding the spring and which is connected with the end of the washing rod (80) and the brush part (82). A plurality of bendable bristles (921) are further attached or fused on an outer surface of the flexible hose (92). Therefore, the brush part (82) and bendable bristles (921) both bent by being pressed allow corner portions and inner wall surfaces in the engine to be washed.

The flexible hose (92) is made of elastic synthetic resin material and fixed to the end of the washing rod (80) and the fixing cap (821) of the brush part (82) by fusion, and the elastic spring (91) is fixed to the end of the washing rod (80) and the fixing cap (821) of the brush part (82) by welding. Therefore, washing is performed while the flexible hose (92) is pressed due to the elasticity of the bent elastic spring (91) and thus washing efficiency can be enhanced.

A washing method using the vehicle engine-washing apparatus configured as above will be described. First, a chemical-introducing step (S1) is performed where washing chemical is introduced through the coupling hole from which the spark plug of the engine has been separated, and a leading-in tube-coupling step (S2) is performed where the leading-in tube (32) of the washing apparatus (10) is introduced into the coupling hole of the engine, and then a brush part-withdrawing step (S3) is performed where after the leading-in tube (32) has been introduced so that an end of the body (31) is caught by the coupling hole, the operation rod (60) is pressed toward the coupling hole to move the connection socket (70) and the washing rod (80) sequentially connected to the operation rod (60), thereby withdrawing the brush part (82) formed at the end of washing rod (80) so that the brush part is exposed from the leading-in tube (32) to the inside of the engine.

Next, a tool-coupling step (S4) is performed where the rotating tool (100) is coupled with the coupling groove (62) formed on the operation rod (60) of the washing apparatus (10), and a washing step (S5) is performed where the rotating tool (100) is rotated to allow the brush part (82) to wash the inside of the engine, and then a discharging step (S6) is performed where the washed chemical is discharged by being pumped through a pump; in his way a series of steps of washing are completed.

Description of reference numerals
10: washing apparatus
20: operation tube
30: guide part
40: holder
50: end cap
60: operation rod
70: connection socket
80: washing rod
90: bendable washing device
31: body
311: through-hole
312: angle-adjusting ring
312a: supporting surface
32: leading-in tube
41: tapered part
42: engagement panel
51: operation hole
61: coupling protrusion
62: coupling groove
81: inserted protrusion
82: brush part
821: fixing cap
822: bristles
91: elastic spring
92: flexible hose
921: bendable bristles
100: rotating tool
B: bearing
S1: chemical-introducing step
S2: leading-in tube-coupling step
S3: brush part-withdrawing step
S4: tool-coupling step
S5: washing step
S6: discharging step

What is claimed is:

1. A vehicle engine-washing engine for washing the inside of vehicle engine, comprising:
a hollow operation tube;
a guide part having a body inserted into a tip portion of the operation tube and formed with a through-hole, and a leading-in tube formed on the body in such a manner as to communicate with the through-hole;
a holder fitted on and fixed to an outer circumferential surface of the operation tube and having a tapered part and an engagement panel formed at an end of the tapered part;
an end cap fitted to a terminal end portion of the operation tube and formed with an operation hole;
an operation rod inserted through the operation hole of the end cap and having a coupling protrusion formed at one end of the operation rod and a coupling groove formed at the other end;
a hollow connection socket disposed in the operation tube, the other end portion of the socket being fitted on the coupling protrusion introduced into the operation tube; and
a washing rod having an inserted protrusion formed at one side thereof which is inserted into one end portion of the connection socket, and a brush part provided at the other side,
wherein the body is further coupled with an annular angle-adjusting ring having a curved supporting surface and made of elastic synthetic resin material, and bearings are further provided in the through-hole of the body and the operation hole of the end cap to prevent frictions of the operation rod and the washing rod.

2. The vehicle engine-washing engine according to claim 1,
wherein the brush part has a fixing cap and multiple bristles, one end of each bristle being fixed in the fixing cap, and the bristles are made of synthetic resin material wires or metal wires.

3. The vehicle engine-washing engine according to claim 1,
wherein the washing rod is further provided with a flexible washing device, and the flexible washing device has an elastic spring connecting an end of the washing rod and the fixing cap of the brush part and a flexible hose which is fitted over the elastic spring while surrounding the spring and which is connected with the end of the washing rod and the brush part, and a plurality of flexible bristles are further formed on an outer surface of the flexible hose.
